(19) United States
(12) Patent Application Publication
(10) Pub. No.: US 2013/0309096 A1
(43) Pub. Date: Nov. 21, 2013

(54) METHOD FOR BONDING MANUFACTURING INTERMEDIARY PARTS, REFERRED TO AS IPS, TO A TURBOMACHINE BLADE MADE OF COMPOSITE MATERIAL

(71) Applicant: SNECMA, (US)

(72) Inventors: Luc Le Bras, Combs La Ville (FR); David Fontaine, Roissy En Brie (FR); Philippe Guillemin, Vitry Sur Seine (FR); Emilie Lesizza, Courbevoie (FR); Dominique Magnaudeix, Yerres (FR); Didier Queant, Saint Fargeau Ponthierry (FR)

(21) Appl. No.: 13/892,730

(22) Filed: May 13, 2013

(30) Foreign Application Priority Data
May 16, 2012 (FR) 12 54479

(51) Int. Cl. B29D 99/00; F01D 5/28

(52) U.S. Cl. CPC B29D 99/0025; F01D 5/282
USPC 416/229 A; 156/285; 156/499

(57) ABSTRACT

A method for bonding additional parts to a composite-material turbomachine part in a thermostatic oven includes a step of placing this composite-material turbomachine part equipped with the additional parts on a rigid support that cannot deform at the operating temperature and pressure and that is configured to espouse the desired final shape of the composite-material turbomachine part. The composite-material turbomachine part equipped with these additional parts is covered with a vacuum bag. The edges of this vacuum bag are sealed with respect to the non-deformable rigid support. A vacuum of determined pressure is applied to the vacuum bag. The determined operating pressure is applied to the vacuum bag in order to hold the composite-material turbomachine part equipped with these additional parts firmly against the non-deformable rigid support, the whole entity thus formed is heated to the operating temperature in the thermostatic oven for a determined time.

### BACKGROUND OF THE INVENTION

The present invention relates to the general field of aeronautical components made of composite material and relates more specifically to a method for bonding manufacturing intermediary parts, referred to as IPs, to turbomachine blades made of composite material.

The intermediary parts in the manufacture of blades, such as the titanium leading edge, the polyurethane wire or even the wear strips, are generally assembled onto the composite-material aerodynamic profile of the blade using a bonding operation performed in an autoclave, these various parts being held in position on the profile by adhesive tapes which are polymerized during this operation.

Now, the parameters of the adhesive of which these tapes are made mean that the temperature at which this adhesive polymerizes is very close to the glass transition temperature of the resin of which the aerodynamic profile is made, which means that the blade becomes deformed by the operation of bonding these IPs and that spread appears on the geometry of the blade thus obtained.

### OBJECT AND SUMMARY OF THE INVENTION

It is therefore the main purpose of the present invention to propose an IP bonding method that alleviates such disadvantages by improving control over the deformations of the composite part.

This purpose is realized by virtue of a method for bonding additional parts to a composite-material turbomachine part in a thermostatic oven, characterized in that it comprises the following steps:

placing said composite-material turbomachine part equipped with said additional parts on a rigid support that cannot deform at the operating temperature and pressure and that is configured to espouse the desired final shape of said composite-material turbomachine part,

covering said composite-material turbomachine part equipped with said additional parts with a vacuum bag, the edges of this vacuum bag being sealed with respect to said non-deformable rigid support using seals,

applying a vacuum of determined pressure to said vacuum bag in order to hold said vacuum bag firmly against said composite-material turbomachine part equipped with said additional parts,

applying said determined operating pressure to said vacuum bag in order to hold said composite-material turbomachine part equipped with said additional parts firmly against said non-deformable rigid support, and heating the whole entity thus formed to said operating temperature in said thermostatic oven for a determined time.

Thus, by making use of a non-deformable rigid support, the geometric conformity of the composite-material turbomachine part is assured and, furthermore, better dimensional repeatability of this part is guaranteed.

According to the planned embodiment, said step of applying said determined pressure to said composite-material turbomachine part equipped with said additional parts is performed either by the inflating of a bladder placed under pressure beforehand or by the pressurizing of said thermostatic oven.

For preference, said determined pressure is comprised between 3 and 5 bar, said vacuum pressure is comprised between 0.1 and 0.9 bar and said heating step is performed at 150° C. for 2 h.

Advantageously, said composite-material turbomachine part equipped with said additional parts rests on said non-deformable rigid support via one of its external faces.

When said composite-material turbomachine part is a blade, said additional parts are intermediary parts (IPs) from among the following: titanium leading edge, polyurethane wire, wear strips.

The invention also relates to the device for bonding additional parts to a composite-material turbomachine part, comprising:

a thermostatic oven,

a rigid support that cannot deform at the operating temperature and pressure and that is configured to espouse the desired final shape of said composite-material turbomachine part,

a vacuum bag to cover said composite-material turbomachine part, the edges of this vacuum bag being sealed with respect to said non-deformable rigid support by means of seals,

means for applying a determined pressure vacuum to said vacuum bag in order to hold said vacuum bag firmly against said composite-material turbomachine part equipped with said additional parts,

means for applying said determined operating pressure to said vacuum bag in order to press said composite-material turbomachine part equipped with said additional parts firmly against said non-deformable rigid support, and

means for heating the whole entity thus formed to said operating temperature in said thermostatic oven for a determined time.

For preference, said means for applying said determined operating pressure to said vacuum bag comprise a bladder.

The invention also relates to a turbomachine blade obtained using the aforementioned bonding method and to the turbomachine comprising at least one such blade.

### BRIEF DESCRIPTION OF THE DRAWINGS

Further features and advantages of the present invention will become apparent from the description given hereinbelow with reference to the attached drawings which illustrate an entirely nonlimiting exemplary embodiment thereof and in which:

FIGS. 1 to 3 schematically illustrate the first three steps in the bonding method according to the invention;

FIG. 4A shows a fourth and final step in the bonding method according to the invention; and

FIG. 4B shows, in an alternative embodiment, a fourth and final step in the bonding method according to the invention.

### DETAILED DESCRIPTION OF THE INVENTION

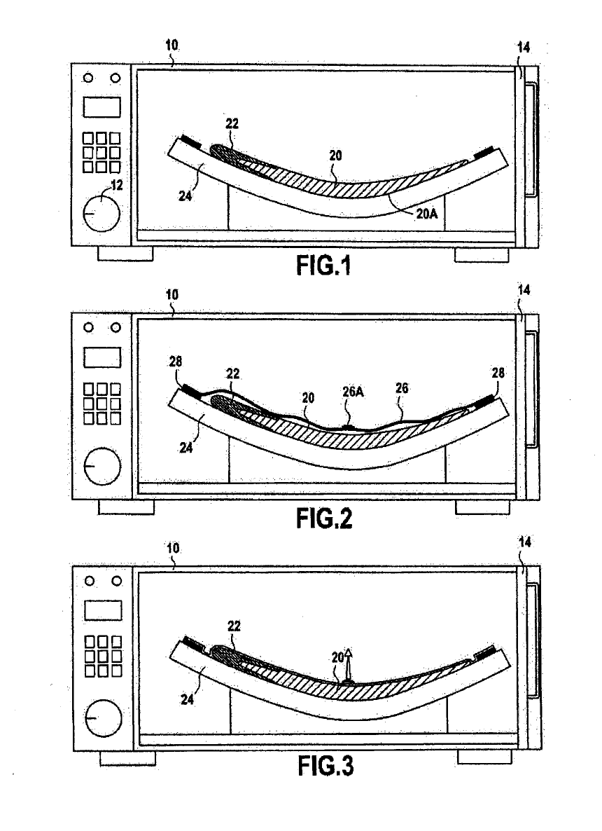

FIGS. 1 to 4A illustrate the various steps of a first embodiment of a method for bonding IPs to a composite-material turbomachine part according to the invention. This method is carried out in a thermostatic oven 10 which is a heating appliance that allows various heat treatments to be carried out at one or more temperature(s) conventionally regulated by a thermostat 12. To ensure an even temperature and the best heat transfer, heating is generally carried out by ventilation. A glazed door 14 allows the progress of the bonding operation to be monitored more easily. The present invention will be described in the context of the production of a blade made of composite material.

Of course, it is not in any way limited to such an aeronautical component and the invention may also be applied, for example, to the bonding of a connecting piece to a fan casing.

The first step of the method is illustrated in FIG. 1. With the oven door open, the blade 20 equipped with its intermediary parts referred to as IPs (in this instance its titanium leading edge 22) is placed on a rigid support 24 that cannot deform at the temperature and pressure of the operating cycle. The blade rests on one of its two external faces and, more particularly as illustrated, on its lower lateral face, in this instance its suction-side face 20A. The rigid support is configured to espouse the final desired shape of the blade, for example a twisted and cambered shape in the case of an RTM composite fan blade with “interlock” architecture.

In a second step illustrated in FIG. 2, the blade is covered with a vacuum bag 26, conventionally a silicone film, which is secured to and sealed with respect to the support 24 by a seal or sealant 28 completely surrounding the blade equipped with its IPs. Thus, covered, in a third step of the method a determined pressure vacuum of between 0.1 and 0.9 bar is created inside this vacuum bag using a vacuum pump (not depicted) connected to a port 26A of the vacuum bag by an air suction hose (not depicted) so that this vacuum bag 26 is held firmly against the upper lateral face of the blade, in this instance its pressure-side face 20B, as illustrated in FIG. 3. The creation of this vacuum allows the wrinkles of the vacuum bag 26 to fill all the spaces around the blade, even the smallest ones around the leading or trailing edges for example.

Once this vacuum has been created and the air suction hose has been removed, the door to the oven 14 can be closed again and the thermostat set to an operating temperature of 150° C. for a determined time of 2 h during which, in order to hold the blade 20 equipped with its IPs firmly against the non-deformable rigid support 24, the determined operating pressure, for example an isostatic pressure of between 3 and 5 bar, is applied to the vacuum bag 26.

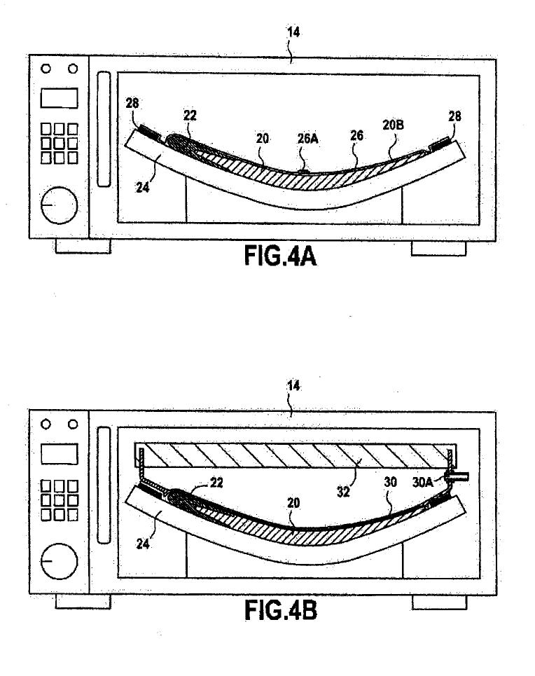

According to the planned embodiment, this pressure applied to the blade 20 may, as illustrated in FIG. 4A, be the result of the simple pressurizing of the thermostatic oven of which the compressed air in direct contact with the blade will then shape this blade onto its support or alternatively may be the result of the inflating of a flexible (stretchable) membrane of bladder type 30 containing compressed air and attached to a beam 32 which forms an integral or non-integral part of the support 24 to which it is mechanically connected (for this purpose its port 30A will have been connected beforehand to a pump (not depicted) by a connector (not depicted) for this pressurizing to the desired pressure), this second embodiment, illustrated in FIG. 4B, having the benefit of limiting both air and power consumption because the pressure is locally better controlled.

Thus, using the invention, perfect control is gained over the deformations of the blade during the operation of bonding of additional parts that the various intermediary parts constitute without the need to resort to usual adhesive tapes. The rigid support by accurately espousing the desired geometry of the blade equipped with its IPs and therefore by allowing it only one position, guarantees that the method is perfectly repeatable (and notably guarantees the dimensional repeatability), synonymous with quality aerodynamic performance.

1. Method for bonding additional parts to a composite-material turbomachine part in a thermostatic oven, characterized in that it comprises the following steps:
placing said composite-material turbomachine part equipped with said additional parts on a rigid support that cannot deform at the operating temperature and pressure and that is configured to espouse the desired final shape of said composite-material turbomachine part,
covering said composite-material turbomachine part equipped with said additional parts with a vacuum bag, the edges of this vacuum bag being sealed with respect to said non-deformable rigid support by means of seals, applying a vacuum of determined pressure to said vacuum bag in order to hold said vacuum bag firmly against said composite-material turbomachine part equipped with said additional parts,
applying said determined operating pressure to said vacuum bag in order to hold said composite-material turbomachine part equipped with said additional parts firmly against said non-deformable rigid support, and heating the whole entity thus formed to said operating temperature in said thermostatic oven for a determined time.

2. Method for bonding according to claim 1, characterized in that the step of applying said determined pressure to said composite-material turbomachine part equipped with said additional parts is performed by the inflating of a bladder placed under pressure beforehand.

3. Method for bonding according to claim 1, characterized in that the step of applying said determined pressure to said composite-material turbomachine part equipped with said additional parts is performed by the pressurizing of said thermostatic oven.

4. Method for bonding according to claim 1, characterized in that said composite-material turbomachine part equipped with said additional parts rests on said non-deformable rigid support via one of its external faces.

5. Method for bonding according to claim 1, characterized in that said composite-material turbomachine part is a blade and said determined pressure is comprised between 3 and 5 bar.

6. Method for bonding according to claim 1, characterized in that said composite-material turbomachine part is a blade and said vacuum pressure is comprised between 0.1 and 0.9 bar.

7. Method for bonding according to claim 1, characterized in that said composite-material turbomachine part is a blade and said heating step is performed at 150° C. for 2 h.

8. Method for bonding according to claim 7, characterized in that said composite-material turbomachine part is a blade and said additional parts are intermediary parts (IPs) from among the following:
titanium leading edge, polyurethane wire, wear strips.

9. Device for bonding intermediary parts to a composite-material turbomachine blade, comprising:
a thermostatic oven,
a rigid support that cannot deform at the operating temperature and pressure and that is configured to espouse the desired final shape of said composite-material turbomachine blade,
a vacuum bag to cover said composite-material turbomachine blade, the edges of this vacuum bag being sealed with respect to said non-deformable rigid support by means of seals,
means for applying a determined pressure vacuum to said vacuum bag in order to hold said vacuum bag firmly against said composite-material turbomachine blade equipped with said intermediary parts,
means for applying said determined operating pressure to said vacuum bag in order to hold said composite-material turbomachine blade equipped with said intermediary parts firmly against said non-deformable rigid support, and
means for heating the whole entity thus formed to said operating temperature in said thermostatic oven for a determined time.

10. Bonding device according to claim 9, characterized in that said means for applying said determined operating pressure to said vacuum bag comprise a bladder.

11. Turbomachine blade equipped with IPs and obtained by the bonding method according to claim 1.

12. Turbomachine comprising at least one blade according to claim 11.
